(19) United States
(12) Patent Application Publication
(10) Pub. No.: US 2019/0329321 A1
(43) Pub. Date: Oct. 31, 2019

(54) Methods For Making A Metal, Sand or Ceramic Object By Additive Manufacture and Formulations For Use In Said Methods

(71) Applicant: PhotoCentriC Limited, Peterborough, Cambridgeshire (GB)

(72) Inventor: Paul Holt, Peterborough, Cambridgeshire (GB)

(73) Assignee: PhotoCentriC Limited, Peterborough, Cambridgeshire (GB)

(21) Appl. No.: 16/349,645

(22) PCT Filed: Nov. 15, 2017
(86) PCT No.: PCT/GB2017/053442

§ 371 Date: May 14, 2019

(30) Foreign Application Priority Data
Nov. 16, 2016 (GB) 1619422.7

(51) Int. Cl. B22F 3/00; B29C 64/165

(52) U.S. Cl. CPC B22F 3/008; B29C 64/129; B29C 64/165

(57) ABSTRACT

This invention relates to compositions and methods for making three-dimensional (3D) images by additive manufacturing or 3D printing. Specifically, it describes techniques that allow images consisting of sand, metal or ceramic particles to be formed by the polymerisation of a photopolymer mixed with the particles.

### FIELD OF THE INVENTION

This invention relates to a method for making a three-dimensional (3D) image by additive manufacturing or 3D printing. Specifically, it describes techniques that enable custom parts consisting of sand, metal or ceramic particles to be made with the rigid orientation of the object governed by the selective photopolymerisation of an organic binder. This process involves depositing a thin layer of solid metal, sand or ceramic particles combined with a photocurable binder in a pre-determined mixing ratio. This layer is then brought into close proximity with an LCD display screen displaying a light and dark image to selectively cure the polymer binder, locking together the particles in those areas that are subject to light irradiation.

### BACKGROUND OF THE INVENTION

This invention lies in the field of 3D printing, also known as rapid prototyping or additive manufacturing. It is a method of creating three dimensional objects in layers each obtained from a digital representation of the object. Typically, an object is scanned in 3 dimensions or generated digitally by computer-aided design (CAD) and split into layers of a pre-determined thickness. These layers are sequentially sent to a 3D printer which builds each layer of the image and moves the build platform away from the imaging source by the thickness of one layer. The printer then starts the process of creating the next layer on top of the layer just laid down. There are a number of different types of 3D printing and thus different methods of creating these layers.

In this invention 3D objects are fixed in position by selectively applying electromagnetic radiation to areas of the liquid photopolymer. More specifically this invention relates to the field of 3D printing where the image source is a visual display screen which emits solely visible light, being between 400 and 700 nm and the screen is not modified to adjust its backlight to generate shorter wavelengths of light below 400 nm. In contrast, all alternative means of 3D printing use an element of UV light to harden the photopolymer.

This novel system of building objects from particles uses selective hardening of a polymeric binder by daylight. There are numerous examples of prior art where the intention has been to create a sand, metal or ceramic object using polymer as a temporary or permanent binder to form the desired shape and some have been successfully commercialised, but all of these methods utilise an element of UV light.

Broadly, there are two methods of creating these objects, either by delivering a layer of particles and polymer and then selectively polymerising the desired areas with a controlled exposure system such as a laser, Digital Light Projector or similar; or by delivering a layer of particles and applying the photopolymer, activator or binder selectively to the desired areas with an ink-jet head dispense system, spray head or similar and then exposing those areas to UV irradiation. In effect one is selectively controlling the light irradiation and the other is selectively controlling the delivery of photopolymer. By way of illustration we cite a number of relevant applications.

U.S. Pat. No. 5,204,055 to Sachs et al., herein incorporated by reference in its entirety, describes methods for making moulds for casting metal by depositing sequential layers of powdered material and selectively applying, a liquid binder material by ink-jet printing method, removing the unbound material and hardening the remaining mould by heat.

U.S. Pat. No. 5,496,682 to Quadir et al., herein incorporated by reference in its entirety, describes methods for making metal or ceramic objects by combining sinterable particles with photopolymer and a dispersant to produce a flowable liquid then flowing a layer of this liquid composition and selectively exposing it to irradiation to polymerise it via a laser. The process being repeated until the object is complete and the polymer is removed by firing the laminate to form a dense body.

U.S. Pat. No. 5,980,813 to Narang et al., herein incorporated by reference in its entirety, describes methods of laying down photopolymer having a covalent bond between metal and non-metal and selectively exposing this layer by a laser followed by heat treating the object to alter the covalent bond between metal and non-metal.

U.S. Pat. No. 6,117,612 to Halloran et al., herein incorporated by reference in its entirety, describes methods of photocuring resins containing metal or ceramic particles having viscosities below 3000 mPas. Here the ceramic particles are loaded at between 50 and 60% by volume of the polymer. The photocurable material and ceramic composition is optimised for refractive index to obtain sufficient image resolution when irradiated with a UV laser.

U.S. Pat. No. 6,416,850 to Bredt et al., herein incorporated by reference in its entirety, describes binding areas of the particles with a non-toxic, water soluble polymer dispensed via an ink-jet head.

U.S. Pat. No. 7,807,077 Hochsmann et al., herein incorporated by reference in its entirety, describes methods for making moulds for casting metal and provides a method to construct a layer of particulates, applying at least a portion of a surface of the particulates with an activation agent and contacting of portion of those activated particulates with a binder material that can react with the activation agent, thus hardening the binder to form a layer of a three-dimensional form. There is a bonding reaction between the binder and the particles to which it is applied. It differentiates its process from the prior art by disclosing a binder which does not react with the particles in the powder layer. As with prior art the binder and the activation unit are dispensed by ink-jet printing techniques or similar.

U.S. Pat. No. 8,506,870 to Hochsmann et al., herein incorporated by reference in its entirety, describes methods where the particulates are substantially free of binder material. In this case the binder and the activation agent are dispensed by ink-jet head or similar.

US patent 2016/0153102 to Watson et al., herein incorporated by reference in its entirety, describes methods of fabricating a metal part by creating the outer surface of an object with polymer, preparing the outer surface with a catalyst, activating it, electroplating it a number of times, evacuating the polymer and filling the resultant holes.

EP 2,502,728 to Ren et al., herein incorporated by reference in its entirety, also describes methods of making an additive manufactured metal object by electroplating a polymer object.

US patent 20160332386 to Kuijpers et al, claims to make 3D printed parts by the deposition of a mix of ceramic and metal particles in a UV sensitive resin, onto a foil substrate. They use a UV light source mounted behind the substrate and the platform holds a stack arrangement of one or more cured layers of resin.

Another method of this technology has been commercialized by 3D Ceram, who utilise high viscosity UV light curable materials in a paste. Their photocurable resin compounds contain ceramic powders hardened by a laser. Another ceramic and UV curable paste layer is then laid down on top of the previous layer followed by another laser illumination. This process is repeated until the final 3D shape is obtained. The parts are then heat treated to de-bind the photocurable resin and then sinter the ceramic particles in order to drive off the resin and densify the ceramic.

WO Patent 2017029673 to Magdassi et al, claims to show formulations for UV ceramic resin which harden by a digital light projector light to make 3D green bodies. It describes de-binding and sintering in the same manner as 3D Cerams's process. They commercialized this concept as the Lithoz ceramic 3D printer.

Patent applications WO2016/181149 and WO2017/051182 (derived from GB 1508178.9, GB 1513771.4 and GB1517025.1) to Holt, herein incorporated by reference in their entirety, describe the use of daylight active photoinitators incorporated into photopolymer that is active enough to polymerise by light emitted from commercially available display screens to create 3D objects.

### SUMMARY OF THE INVENTION

This invention involves metal, sand or ceramic objects being created wherein the material the object is made from is composed of particles of the same material held together by a polymeric binder. The particles and the polymeric binder are deposited in a layer by layer manner. These layers are sequentially cured in light above 400 nm and below 700 nm in wavelength, the light being emitted from a display screen suitable for human viewing. These can be used to make sand castings for metal moulds or to make solid ceramic or metal objects directly.

Surprisingly, it has been found that by using visible light as the polymerising light it is possible to derive accurate representations of the digital design in an object that consists of solid particles held together by the binder. This provides significant advantages over alternative methods of selective polymerisation, namely lasers and Digital Light Projectors which create orders of magnitude more energy which has to be absorbed or dissipated in the structure during its creation. The excess unwanted light can compromise the accuracy of the objects eventual resolution because of light striking the irregularity of the position and shape of the particles. In contrast the nature of daylight polymerisation is that the photoinitiator has to have colour to absorb visible light photons, which in turn means that it is difficult for the light to transmit deeper into the polymer through the already polymerised pigmented material, thus it becomes self-stabilising in its exposure depth, does not scatter the light and overcomes a lot of the problems in this respect with the prior art.

Furthermore, because the LCD screen exposes every voxel of the area simultaneously across its entire format, it is considerably more effective at polymerising large volumes of solid object than all alternative methods which can only harden a voxel in the case of a laser, or a very small area in the case of a DLP, at a time.

After the final layer has been polymerised, the vat containing the object and uncured matter is transferred to a rinse tank where water plus an optional additional solvent is flushed through it to remove the uncured polymer and particles. This mixture can be separated to allow the reuse of the particles.

The resultant structure can optionally be subject to some further post treatment of light illumination if necessary to cure it further. What remains is the desired structure of particles held together by a solidified photopolymer binder.

In the case of sand particles, the object can be used as a casting or mould for molten metal. In the case of ceramic or metal particles, the object can be fired to remove the organic polymer and then elevated in temperature towards the sintering temperature of the material at which point the metal or ceramic will fuse together.

In a first aspect of the invention is provided a particulate mixture for forming 3-dimensional when exposed to visible light, the mixture comprising:
a liquid photopolymer formulation; and
a plurality of particles;

wherein the photopolymer formulation comprises:
at least one monomeric or oligomeric chemical species each comprising at least one carbon-carbon double bond which is polymerisable by free radical polymerisation present in a total amount of from 40 to 90% by weight;
at least one titanocene photoinitiator present in a total amount of from 0.1 to 10% by weight;
at least one coinitiator present in a total amount of from 0.5 to 20% by weight.

In a second aspect of the invention is provided a liquid photopolymer formulation for mixing with a plurality of particles to form a particulate mixture of the first aspect, wherein the photopolymer formulation comprises:
at least one monomeric or oligomeric chemical species each comprising at least one carbon-carbon double bond which is polymerisable by free radical polymerisation present in a total amount of from 40 to 90% by weight;
at least one titanocene photoinitiator present in a total amount of from 0.1 to 10% by weight;
at least one coinitiator present in a total amount of from 0.5 to 20% by weight.

The total amount of titanocene present in the photopolymer formulation may be from 0.5 to 2.5% by weight. The titanocene may be from: bis(η⁵-2,4-cyclopentadien-1-yl)bis[2,6-difluoro-3 -(1H-pyrrol-1-yl)phenyl]titanium, titanocene bis(trifluoromethanesulfonate), titanocene dichloride, (indenyl)titanium (IV) trichloride, (pentamethylcyclopentadienyl)titanium (IV) trichloride, cyclopentadienyltitanium (IV) trichloride, bis(cyclopentadienyl)titanium (IV) pentasulfide, (4R,5R)-chloro-cyclopentadienyl-[2,2-dimethyl-1,3-dioxolan-4,5-bis(diphenylmethoxy)]titanium, (4S,5S)-chloro-cyclopentadienyl-[2,2-dimethyl-1,3-dioxolan-4,5-bis(diphenylmethoxy)]titanium or a mixture thereof. The titanocene may be bis(η⁵-2,4-cyclopentadien-1-yl)-bis(2,6-difluoro-3 -(1H-pyrrol-1-yl)-phenyl) titanium.

The total amount of coinitiator present in the photopolymer formulation may be from 1 to 10% by weight. The coinitiator may be a thiol coinitiator. The coinitiator may be selected from 2-mercaptobenzoxazole, 2-mercaptobenzothiazole, 2-mercaptobenzimidazole, pentaerythritol-tetrakis(mercaptoacetate), 4-acetamidothiophenol, mercaptosuccinic acid, dodecanthiol, betamercaptoethanol, 6-ethoxy-2-mercaptobenzothiazole, 4-methyl-4H-1,2,4-triazole-3-thiol, 2-mercapto-1-methylimidazole, 2-mercapto-5-methylthio-1,3,4-thiadiazole, 5-n-butylthio-2-mercapto-1,3,4-thiadiazole, 4-methoxybenzene thiol, 1-phenyl-1H-tetrazole-5-thiol, 4-phenyl-4H-1,2,4-triazole-3-thiol, pentaerythritol-tetrakis(3-mercaptopropionate), trimethylolpropane-tris(mercaptoacetate), 2-mercaptopyridine, 4-mercaptopyridine, 2-mercapto-3H-quinazoline and 2-mercaptothiazoline or a mixture thereof.

The photopolymer formulation comprises a flow modifying agent.

The particles may be sand or mixture of sand and a binder selected from glass and organic binder. It may be that the particles are a mixture of sand and glass. It may be that the particles are sand. It is also possible to make 3D printed sand objects by mixing the sand particles with inorganic binders such as borosilicate glass or low temperature glass. When the 3D objects are made the heat will de-bind the organic resin and fuse the inorganic binder by heat. The photopolymer binder can be used at 20-30% by weight with the inorganic binder at the same ratio of 20-30% by weight.

The particles may be metal or ceramic or a mixture thereof. Metal particles may be pure metals or they may be metal alloys.

In a third aspect of the invention is provided a method for creating a 3-dimensional object, the method comprising:
a) forming a layer of a particulate mixture of the first aspect
b) exposing the layer of the particulate mixture to visible light to form a cured layer; and
c) sequentially repeating steps a) and b), with each layer of particulate mixture being laid on top of each previously cured layer, to form a 3-D object formed of particles bound together by cured photopolymer.

It may be that the particulate mixture that is formed into a layer is pre-mixed. Alternatively, it may be mixed in situ. Thus, it may be that step a) comprises:
forming a layer of the particles; and
applying the liquid photopolymer resin to the particles to form the layer of the particulate mixture.

It may be that the liquid photopolymer is applied uniformly to the particles across the layer. Alternatively, it may be that the liquid photopolymer is applied selectively to certain portions of the layer of particles to form an image, said image being a cross-section of the desired 3-D object. It may be that the liquid photopolymer formulation is applied to the particles using an ink jet printer.

It may be that the visible light is from a visual display screen and is in the form of an image, said image being a cross-section of the desired 3-D object. It may be that the visual display screen is a liquid crystal display screen (LCD). Alternatively, where the liquid photopolymer has been applied selectively, it may be that the layer is exposed uniformly to the visible light.

The method may further comprise washing the 3-D object comprising the particles bound by the cured photopolymer to remove excess particles and/or excess photopolymer formulation.

Where the particles are metal or ceramic, the method may further comprise heating the 3-D object formed of particles bound together by cured photopolymer to form a metal or ceramic 3-D object. The step of heating the object may comprise:
heating the 3-D object formed of particles bound together by cured photopolymer to a first temperature to remove the cured photopolymer;
heating the resultant 3-D object to a second temperature, higher than the first temperature, to sinter the particles to form the metal or ceramic 3-D object.

It may be that the object is supported by a heat resistant material as it is heated.

According to a fourth aspect, there is provided a 3D printer, the apparatus comprising:
a source of light suitable for human viewing;
a build platform having a build surface for use whilst stereolithographically printing a 3D object;
an actuation mechanism for varying the separation of the build surface and the source of light; and
a deposition mechanism for depositing a deposition material of particulate or a particulate-photopolymer mixture.

### BRIEF DESCRIPTION OF THE DRAWINGS

Embodiments of the invention are further described hereinafter with reference to the accompanying drawings, in which:

FIG. 1 shows an exemplary apparatus suitable for carrying out the methods of the invention. This schematic is shown with a number of layers constructed and the screen in the process of illuminating the layer beneath.

FIG. 2 shows the actions after the completion of the exposure cycle. The screen has now turned off and has been lifted upwards out of the way. The platform that holds the polymerised build object and non-polymerised particles and polymer is then lowered down by one layer thickness.

FIG. 3 shows the deposit of the layer of particles, either dry or pre-incorporated with photopolymer being swept level by the doctor blade or roller.

FIG. 4 shows the optional stage where the spray head layers an even distribution of photopolymer onto the dry particles.

FIG. 5 shows the screen returning down to come into close proximity to the layer, before commencing the process again described in FIG. 1.

### DETAILED DESCRIPTION

The present invention is a new method of manufacturing solid objects of predominantly sand, metal or ceramic by 3D Printing or Additive Manufacturing, comprising the steps of delivering a layer of particles and photopolymer and bringing this layer into close proximity to a display screen to be exposed by visible light emitted from it, and then repeating the process to form the remainder of the three-dimensional form.

The photopolymer and particles have to be incorporated together before irradiation. This can be performed in a separate operation, with the polymer mixed into the particles in a separate vat before being transferred to the 3D printer to be levelled as a layer of wet mix. Alternatively, this can be done by delivering a layer of dry particles with the polymer dispensed on top afterwards. This can be performed as two separate steps or combined in a single delivery head.

The particles of this invention may be any suitable finely divided material that is capable of being bonded to form an aggregate with a photocurable binder. The particles may be organic, inorganic or a mixture thereof. The particles may be sand, metal, ceramic, polymeric, organic, combinations thereof or the like.

The particles are chosen to be of a size and shape to enable their optimal orientation in solid form. The particles may be incorporated at the maximum concentration possible while still enabling the necessary structural strength or permeability to be achieved after light polymerisation of the binding polymer.

In the case that the particles are sand or silica they could be quartz, zircon, olivin, magnetite, or a combination thereof. The sand may be virgin sand, reclaimed sand, or a combination thereof. The sand may also include components to make it function better as a foundry mould such as carbonaceous additives. It is desirable that the polymerized structure has the sand particles adhered to each other strongly while still retaining a highly porous structure that is permeable to enable the evacuation of gasses created during the process of the molten metal cooling. In the case of a sand mould it is desirable that less than about 30%, less than about 10%, or less than 2% of the total weight of the particulate mixture is photopolymer. It may be that more than about 20% of the particulate mixture is photopolymer. Preferably the particles are of the same order of size. Preferably they have an average particle size ranging from 10 μm to about 500 μm, more preferably about 100 μm to about 200 μm, and still more preferably of the order of 150 μm. The sand particles may be mixed with glass particles. In this case, the glass particles may comprise from 20% to 30% by weight of the particulate mixture.

In the case that the particles are metallic or ceramic they are designed to be sintered and the particles are ideally of a narrow distribution in size and of a similar size and shape to achieve a high final density, although dissimilar shapes and sizes are possible. Smaller particles have been found to have more favorable sintering characteristics.

Preferably, the sinterable particles have an average particle size of about 0.05 to 10 μm, more preferably about 1-5 μm. Preferably, the % volume of sinterable particles in the particulate mixture is about 40-90% by volume, more preferably about 60-70% by volume.

Larger and smaller particle sizes are also possible and the above ranges are not intended as limiting of the invention.

In the present invention, the base of the photopolymer formulation may be any light reactive system, including, but not limited to those based on phenol-formaldehyde, urethane acrylate and epoxy acrylate oligomers. Thus, the base of the photopolymer will typically comprise one or more monomeric or oligomeric chemical species each comprising at least one carbon-carbon double bond which is polymerisable by free radical polymerisation. The term oligomer includes compounds having a few monomer units, e.g. dimers, trimers and tetramers etc. of monomers. The photocurable composition may be any suitable oligomer or monomer or combination thereof which can form a polymer of sufficient strength when illuminated with visible light. The oligomer can be created by reacting any suitable polyol with an isocyanate, optionally toluene diisocyanate. This may take place in a stainless steel or glass vessel. The relative proportions of the two reactants are determined by their OH values with the reaction taking place in the presence of a catalyst such as n-butyl tin dilaurate.

Examples of epoxy compounds which may be used in accordance with the present invention are bisphenol A type epoxy resins, bisphenol F type epoxy resins, phenol-formaldehyde epoxy resins, heterocyclic ring-containing epoxy resins such as triglycidyl isocyanurate and hydantoin epoxy, hydrogenated bisphenol A type epoxy resins, aliphatic epoxy resins such as propylene glycol diglycidyl ether and pentaerythrytol polyglycidyl ethers, glycidyl ester type epoxy resins obtained by the reaction of an aromatic, aliphatic or cycloaliphatic carboxylic acid with epichlorohydrin, spiro-ring containing epoxy resins, glycidyl ether type epoxy resins obtained by the reaction of an ortho-allylphenol phenol-formaldehyde compound with epichlorohydrin, glycidyl ether type epoxy resins obtained by the reaction of epichlorohydrin with a diallyl bisphenol compound having an allyl group at the ortho-position with respect to each hydroxy group of bisphenol A, and the like.

Acid anhydrides which may be used as curing agents for the epoxy compounds in accordance with the present invention include phthalic anhydride, hexahydrophthalic anhydride, tetrahydrophthalic anhydride, methyltetrahydrophthalic anhydride, methylhexahydrophthalic anhydride, nadic anhydride, methylnadic anhydride, chlorendic anhydride, dodecenylsuccinic anhydride, methylsuccinic anhydride, benzophenonetetracarboxylic anhydride, pyromellitic anhydrie, maleic anhydride and the like. These acid anhydrides are preferably used in an amount of 1.0 equivalent or less based on the epoxy compounds.

The phenolic compounds which may be added to the epoxy resins in accordance with the present invention may, for example, be bisphenol A, bisphenol F, bisphenol S, and condensates of formaldehyde and the like with phenols such as phenol, cresol and bisphenol A. These phenolic compounds are preferably used in an amount of 0.8 equivalent or less based on the epoxy compounds. In addition, liquid pre-reacted adducts of such epoxy resins with hardeners are suitable for epoxy resins. It is also possible to use mixtures of epoxy resins in the compositions according to the invention.

In the case of sand particles, it is desirable that the material has a high heat deflection temperature. It has been found that compounds containing phenol-formaldehyde resins with a formaldehyde to phenol molar ratio of less than one such as novolac epoxies provide such properties. It is desirable that the photopolymer formulation for sand moulds contain 40-90% of said phenol-formaldehyde resins by volume, more preferably about 50-70% by volume. Epoxy phenol formaldehyde resins have a higher functionality with more than 2 epoxy groups per molecule and create high Tg, rigid, hard, heat and chemical resistant photopolymerisable compounds.

In the case of metal and ceramic particles, it is desirable that a functionalised epoxy or urethane (meth)acrylate is used to provide greater reactivity.

Epoxy (meth)acrylates may, for example, be an epoxy (meth)acrylate of a polyepoxy compound such as (poly)ethylene glycol polyglycidyl ether, (poly)propylene glycol polyglycidyl ether, (poly)tetramethylene glycol polyglycidyl ether, (poly)pentamethylene glycol polyglycidyl ether, (poly)neopentyl glycol polyglycidyl ether, (poly)hexamethylene glycol polyglycidyl ether, (poly)trimethylolpropane polyglycidyl ether, (poly)glycerol polyglycidyl ether or (poly)sorbitol polyglycidyl ether, with a hydroxy (meth)acrylate compound such as hydroxymethyl (meth)acrylate or hydroxyethyl (meth)acrylate.

Urethane acrylates are compounds having a radically-polymerizable ethylenic double bond, e.g. one which undergoes addition polymerization by the action of a photopolymerization initiation system when the photosensitive composition is selectively irradiated with daylight. Typical urethane acrylates are poly(meth)acrylate resins, for example polyether urethane polymers, or polyether polyester urethane copolymers such as polyether polyester urethane methacrylate photopolymers, polyester resins, unsaturated polyurethane resins, unsaturated polyamide resins.

Upon irradiation, the polymer will undergo crosslinking and become tough and resilient, however in the areas where it is not irradiated it will remain liquid. The epoxy or urethane acrylate is selected to provide the desired rate of polymerisation, toughness and crosslinking properties, while achieving a steady and even burning with low thermal expansion and minimal ash content. In its un-exposed state it is soluble in a solvent, suitably water so unexposed polymer and is easily removed afterwards. The invention is not limited in use to this choice of oligomer and anyone skilled in the art could construct alternative polymers using alternative oligomers by applying these principles so described.

Experimentation has shown that organometallic and specifically metallocene photoinitiators are most suitable for the invention, most desirably titanocene based photoinitiators give optimum rates of polymerisation. Examples of suitable titanocenes are bis(η⁵-2,4-cyclopentadien-1-yl)bis[2,6-difluoro-3 -(1H-pyrrol-1-yl)phenyl]titanium, titanocene bis(trifluoromethanesulfonate), titanocene dichloride, (indenyl)titanium (IV) trichloride, (pentamethylcyclopentadienyl)titanium (IV) trichloride, cyclopentadienyltitanium (IV) trichloride, bis(cyclopentadienyl)titanium (IV) pentasulfide, (4R, 5R)-chloro-cyclopentadienyl-[2,2-dimethyl-1,3-dioxolan-4,5-bis(diphenylmethoxy)]titanium, (4S, 5S)-chloro-cyclopentadienyl-[2,2-dimethyl-1,3-dioxolan-4,5-bis(diphenylmethoxy)]titanium, and the like. The photoinitator used is most preferably bis(η⁵-2,4-cyclopentadien-1-yl)-bis(2,6-difluoro-3-(1H-pyrrol-1-yl)-phenyl) titanium which is manufactured by BASF under the tradename Irgacure 784 (Irg.784). This photoinitiator reacts mainly to the photons emitted from the blue and green sub-pixels, but not the red in an LCD screen.

It has been found that in systems wherein titanocene based polymer systems are activated solely by daylight, there is no growth until a lower threshold of illumination is reached, then the rate of growth is roughly linear up to an upper threshold of illumination, after that it has been found that the rate of growth with increase in time declines to almost zero. Illumination here means a continuous exposure of the same intensity of daylight for an increasing time measured in seconds. It is proposed that the absence of growth after a threshold is reached may be caused by the relatively low energy of the daylight radiation providing ample opportunity for the photons to strike cured matter and impart their energy instead of travelling further through to reach liquid polymer on the other side of the cured matter. This makes the system in effect, self-stabilising as is significant in compositions where the particular particle loading can deflect the light.

It may be that the total amount of titanocene present is from 0.5 to 5% by weight or more preferably that the total amount of titanocene present is from 0.9 to 2.5% by weight of the photopolymer.

It has been found that the rate of polymerisation can be greatly enhanced by the addition of at least one coinitiator. A coinitiator as referred to in the present invention is a compound that can generate free radicals when itself activated by the activated photoinitiator but which does not itself absorb light in the visible spectrum. The coinitiators can for example be selected from onium compounds, for example those where the onium cation is selected from iodonium, sulfonium, phosphonium, oxylsulfoxonium, oxysulfonium, sulfoxonium, ammonium, diazonium, selenonium, arsenonium and N-substituted N-heterocyclic onium cations wherein N is substituted with an optionally substituted alkyl, alkenyl, alkinyl or aryl (e.g. N-alkoxypyridinium salts); N-arylglycines and derivatives thereof (e.g. N-phenylglycine); aromatic sulfonyl halides; trihalomethylsulfones; imides such as N-benzoyloxyphthalimide; diazosulfonates; 9,10-dihydroanthracene derivatives; N-aryl, S-aryl or O-aryl polycarboxylic acids with at least two carboxy groups of which at least one is bonded to the nitrogen, oxygen or sulfur atom of the aryl unit (e.g. aniline diacetic acid and derivatives thereof, hexaarylbiimidazoles; thiol compounds (otherwise known as mercaptans) (e.g. mercaptobenzthiazoles, mercaptooxadiazoles, mercaptotetrazines, mercaptoimidazoles, mercaptotetrazoles, mercaptopyridines, mercaptooxazoles and mercaptotriazoles; they include 2-mercaptobenzoxazole, 2-mercaptobenzothiazole, 2-mercaptobenzimidazole, pentaerythritol-tetrakis(mercaptoacetate), 4-acetamidothiophenol, mercaptosuccinic acid, dodecanthiol, betamercaptoethanol, 6-ethoxy-2-mercaptobenzothiazole, 4-methyl-4H-1,2,4-triazole-3-thiol, 2-mercapto-1-methylimidazole, 2-mercapto-5-methylthio-1,3 ,4-thiadiazole, 5-n-butylthio-2-mercapto-1,3,4-thiadiazole, 4-methoxybenzene thiol, 1-phenyl-1H-tetrazole-5-thiol, 4-phenyl-4H-1,2,4-triazole-3-thiol, pentaerythritol-tetrakis(3-mercaptopropionate), trimethylolpropane-tris(mercaptoacetate), 2-mercaptopyridine, 4-mercaptopyridine, 2-mercapto-3H-quinazoline and 2-mercaptothiazoline); 1,3,5-triazine derivatives with 1 to 3 CX3 groups (wherein every X is independently selected from a chlorine or bromine atom, and is preferably a chlorine atom), such as e.g. 2-phenyl-4,6-bis(trichloromethyl)-s-triazine, 2,4,6-tris(trichloromethyl)-s-triazine, 2-methyl-4,6-bis(trichloromethyl)-s-triazine, 2-(styryl-4,6-bi s(trichloromethyl)-s-triazine, 2-(p-methoxystyryl)-4,6-bis(trichloromethyl)-s-triazine, 2-(4-methoxy-naphtho-1-yl)-4,6-bistrichloromethyl-s-triazine, 2-(4-ethoxy-naphtho-1-yl)-4,6-bis(trichloromethyl)-s-triazine and 2-[4-(2-ethoxyethyl)-naphtho-1-yl]-4,6-bis(trichloromethyl)-s-triazine; oxime ethers and oxime esters, such as for example those derived from benzoin; α-hydroxy or α-amino acetophenones; mono-, di- and triacylphosphine oxides, and peroxides.

It has been found that thiol or mercaptan coinitiators are particularly suitable to enhance the rate of growth of polymer when irradiated with low intensity daylight and also provide the finished object with a dry surface finish. Thus, a suitable coinitiator may be a described by the formula X—(SH)n where X represents any organic moiety, and n represents a number from 1 to 10. It is possible to incorporate those mercaptans into resins such as mercapto-modified polyester acrylate resin and these compositions have a similar effect to unmodified thiols in respect of this invention. Preferably, the at least one coinitiator comprises thiol groups. Thus, the coinitiator may be a compound defined by the formula X−(SH). where X represents any organic moiety, and n represents a number from 1 to 10. Such compounds are hereafter referred to as ‘thiols’. Thus, the coinitiator may be selected from 2-mercaptobenzoxazole, 2-mercaptobenzothiazole, 2-mercaptobenzimidazole, pentaerythritol-tetrakis(mercaptoacetate), 4-acetamidothiophenol, mercaptosuccinic acid, dodecanthiol, betamercaptoethanol, 6-ethoxy-2-mercaptobenzothiazole, 4-methyl-4H-1,2,4-triazole-3-thiol, 2-mercapto-1-methylimidazole, 2-mercapto-5-methylthio-1,3,4-thiadiazole, 5-n-butylthio-2-mercapto-1,3,4-thiadiazole, 4-methoxybenzene thiol, 1-phenyl-1H-tetrazole-5-thiol, 4-phenyl-4H-1,2,4-triazole-3-thiol, pentaerythritol-tetrakis(3-mercaptopropionate), trimethylolpropane-tris(mercaptoacetate), 2-mercaptopyridine, 4-mercaptopyridine, 2-mercapto-3H-quinazoline and 2-mercaptothiazoline or a mixture thereof. The coinitiator may be pentaerythritol tetrakis(3-mercaptopropionate). The coinitiator may be an oligomeric moiety comprising thiol groups, e.g. a mercaptomodified polyester acrylate.

An ‘organic moiety’ is intended to mean any hydrocarbyl group or group of hydrocarbyl groups, for example one or more hydrocarbyl group selected from an alkyl group, cycloalkyl group, aromatic group, heteroaromatic group, heterocyclic group, alkenyl group, any of said groups being substituted by or linked together by an aldehyde, halogen, ketone, carboxyllic acid or ester, ether, thioether, amine, amide functionality.

A thiol group is a —S—H group, the —S—H group being typically attached to a carbon atom in an organic moiety. Such groups are sometimes referred to as mercaptans. A thiol coinitiator is a coinitiator that comprises a thiol group.

It may be that the total amount of coinitiator present is from 0.5 to 10% by weight, preferably it may be that the total amount of coinitiator present is from 1 to 5% by weight in the photopolymer.

The composition can, for example, contain certain reactive diluents to bring additional properties to the resin and also modify its viscosity and surface tension. In certain embodiments, the composition further comprises one or more performance-enhancing additives including, for example, esters of acrylic or methacrylic acid, stabilisers, surface tension modifiers and wetting agents.

The formulation may comprise at least one stabiliser to prevent over-exposure. Stabilisers can be either daylight absorbers which convert light into heat, such as 2-hydroxyphenyl-benzophenones, 2-(2-hydroxyphenyl)-benzotriazoles, or 2-hydroxyphenyl-s-triazines, or they are antioxidants that also deactivate the free radicals such as sterically hindered phenols, phosphites and thioethers. Preferably these stabilisers are for example Tinuvin 292 from BASF 1,2,2,6,6-pentamethyl-4-piperidyl methacrylate, 2-hydroxy-4-n-octoxybenzophenone, 2(2′-hydroxy-5′-methylphenyl)benzotriazole or N,N-dimethyl benzylamine. There are also residual amounts of stabilisers such as hydroquinone present in the oligomers and reactive diluents.

Alternatively, the photopolymer formulation may be free of stabilisers. It has been found that these daylight activated formulations do not require any additional stabilisers as the intensity of light present in non-intended areas is below the threshold necessary to initiate polymerisation. This is important in the creation of high resolution sand, metallic and ceramic loaded objects as these particles can refract the light after impact and create over-exposure. Alternative photocurable chemistries are also possible and the above types are not intended as limiting of the invention.

The desired thickness of the layer of particles may vary depending on the desired precision of the stereo photolithographic layering and the depth of cure provided by the mixture. Preferably, the layer thickness is from 50 to 500 μm, more preferably from 100 to 250 μm. It will be understood that layer thickness is subject to manufacturing tolerance, which may cause a microscopic difference in thickness of two layers that would be considered to be of the same thickness. The thicker the layers, the less time is needed to polymerise the total object, but countering this very thick layers containing particles are slow to fully polymerise. Preferably, the time to expose each layer is less than two minutes, more preferably it is less than one minute.

In the case of 3D printing using photopolymer containing high solid particle contents e.g. sand, metal or ceramics, the particulate mixtures are not disposed to be positioned evenly into thin coatings quickly by liquid flow alone. It is therefore more practical to deposit an even layer of the dry solid particles and uniformly coat with photopolymer or to deposit a layer of pre-coated particles, and then to selectively harden the layer with a laser, DLP or similar. Each layer of cured polymer is a 2D image, representing a cross-section of the completed object. It may be that all layers of cured polymer form different images.

The screens used in certain methods of the invention may be suitable for human viewing. The screens used in certain methods of the invention may emit little or no UV radiation. Using ‘off-the-shelf’ display screens means that the cost of producing a 3D printer which carries out the method of this invention is lower than it would be if the backlighting of the screen had been replaced with a more intense predominantly UV light. Typically, bulbs which offer an increased intensity of light also emit significant amounts of UV light. A 3D printer which carries out the method of the invention might be expected to have a greater longevity than one using a screen with a backlight which has been modified to provide a more intense light source. Screens that emit little or no UV light are inherently safer to the human eye than those that emit a high level of UV light.

Visual display screens used for human viewing emit orders of magnitude less light than the light sources used in existing UV emitting 3D printers. A normal LCD screen emits of the order of 300 cd/m², whereas the typical DLP projector in a 3D printer emits orders of magnitude greater, at around 3000 lumens.

It may be that the visual display screen is suitable for human viewing. It may be that the visual display screen is adapted for human viewing. The visual display screen may be an ‘off-the-shelf’ screen. The visual display screen may be a television, a computer monitor, a laptop, a mobile device such as a smart phone or a tablet computer such as an iPad®. The screen may be unmodified after manufacture.

LCD screens manufactured for human viewing are typically illuminated by LED backlights. As LEDs used to backlight LCD screens emit a single frequency they have no emissions in the UV region. Visual display screens adapted for human viewing typically emit no light in the UV region. The distribution of wavelengths emitted by a screen will typically be available as a graph as part of the manufacturer's technical data package. Integration of the relevant portions of that graph can be used to determine the proportion of the light emitted which is UV light. The distribution of radiation, and therefore the relative proportions of the components of that radiation, may also be determined using a light meter configured to measure the amount of light emitted across the appropriate ranges of wavelengths.

It may be that the visual display screen has a luminance of between 100 and 5000 (e.g. between 100 and 2000) candela per square metre (cd/sqm). Thus, it may be that the visual display screen has a luminance of between 200 to 400 cd/sqm. The visual display screen may have a luminance of greater than 175 cd/sqm. The visual display screen may have a luminance of greater than 500 cd/sqm. The luminance is intended to mean the total luminance, i.e. the sum of the individual luminances for UV radiation, visible light, IR radiation, etc. and may be determined using a light meter configured to measure the amount of light emitted across the range of wavelengths emitted by the screen. Thus, the luminance of a screen can be measured using a luminance meter such as the LS-100 made by Konica. This instrument can provide accurate measurements of the cd/sqm and produce and accurate relative photopic luminosity curve. The test procedure is to turn the screen on for 5 minutes to allow it to reach maximum emission and then in a dark enclosure place the LS-100 on the screen and take the reading in cd/sqm.

The visual display screen may be an LCD. The visual display screen may be an LED, an organic light emitting diode type (OLED), a polymer light emitting diode type (PLED), an electroluminescent display type (ELD) or a plasma display panel type (PDP) or other. The type of screen is not critical to this invention, merely that it displays images and that those images are in daylight. This invention utilises novel photopolymer formulations which are highly active in the visible light region. This enables the use of unmodified LCD screens manufactured for human viewing with light generated by light emitting diode (LED) backlights that are emitting solely daylight. As LEDs emit a single frequency they have no emissions in the ultra violet (UV) region.

An LCD typically consists of an array of pixels. Each pixel consists of a layer of liquid crystal molecules aligned between two transparent electrodes and two polarizing filters (parallel and perpendicular), the axes of transmission of which are, in most of the cases, perpendicular to each other. Before an electric field is applied, the orientation of the liquid-crystal molecules is commonly twisted, the surface alignment directions at the two electrodes are perpendicular to each other and so the molecules arrange themselves in a helical structure. By controlling the voltage applied across the liquid crystal layer in each pixel, light can be allowed to pass through in varying amounts thus creating different levels of grey.

It may be that the visual display screen has 100 pixels per inch or greater. It may be that the visual display screen has 175 pixels per inch or greater. It may be that the visual display screen has a ratio of its contrast ratio to its luminescence that is above 1.0.

The length of time that the screen illuminates the image is determined by the rate of curing of the photopolymer and the intensity of light being emitted from the screen thus curing it.

The photopolymer may be in direct contact with the visual display screen. The photopolymer may be separated from the visual display screen by a gaseous layer. The photopolymer may be separated from the visual display screen by a filmic layer. It may be that the film is a perfluoroalkoxy copolymer or a fluorinated ethylene propylene. It may be that the visual display screen is coated with a low surface energy coating, e.g. a silicone coating. It may be that the top of layer of photopolymer and particles is in direct contact with the visual display screen.

The build platform that the solid object will be formed on within the 3D printer is lowered by the thickness of a layer T into the machine housing and particles and photopolymer are dispensed into the tray to the level of the upper surface of the tray.

In practice, they can be smoothed level by a doctor blade, a counter-rotational roller or similar device. The housing and build platform are desirably made from a light strong and non-flexible material, preferably aluminium or stainless steel.

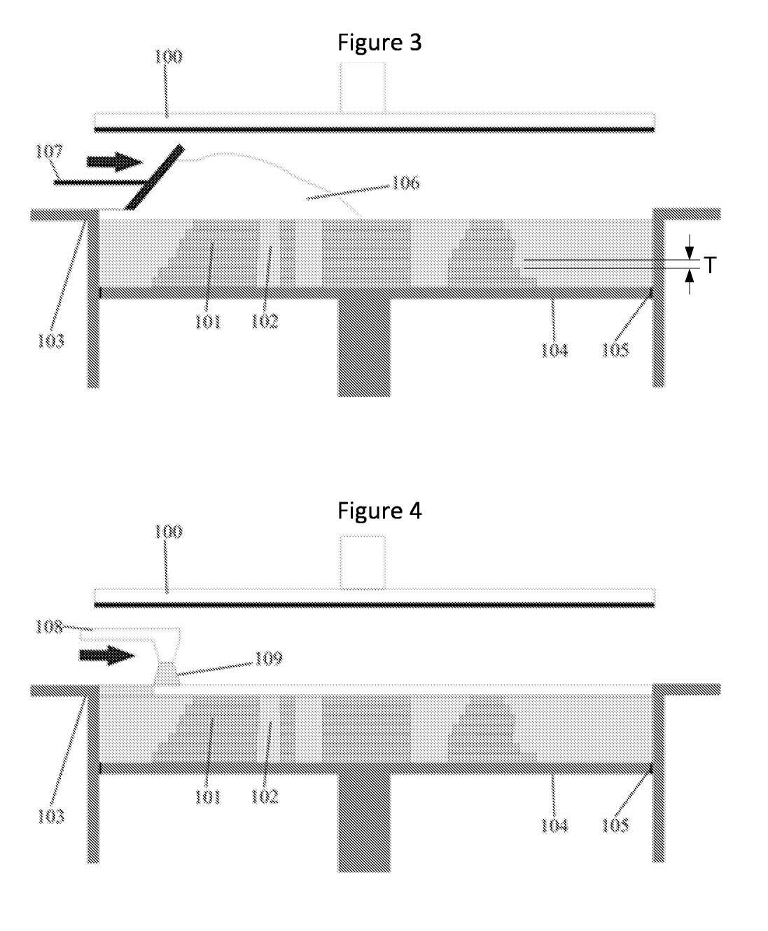

FIG. 3 shows this configuration where 100 is a visible light emitting display screen to provide the selective illumination. The particles 106 are smoothed out by a doctor blade or roller 107 (or roller) to deliver them level with the top of the machine 103. A seal is made between the build platform 104 and the machine housing 103 using a gasket 105. The build platform 104 supports both solidified material 101 and uncured polymer and particles 102.

FIG. 4 shows the even delivery of photopolymer 109 from the spray head 108 over the particles to produce coated particles 102. In the case of a sand object being created the photopolymer is preferably delivered in a thin layer to coat the sand particles and adhere them together with a large percentage of the volume remaining air. In the case of metal and ceramic particles very little, if any of the voids between the particles remains as air.

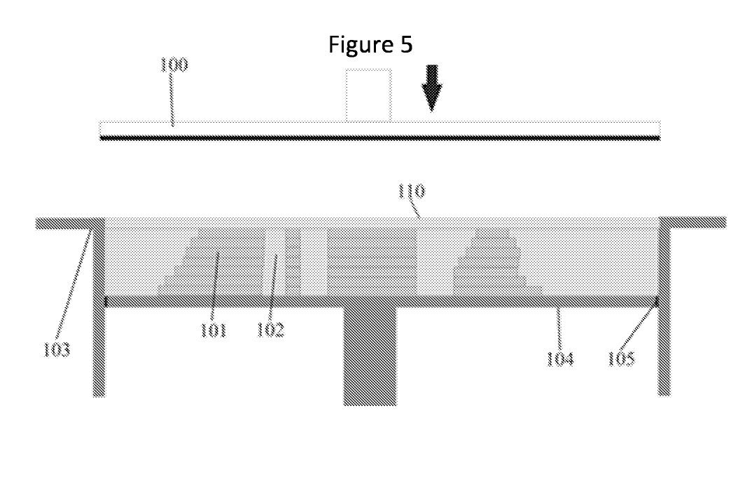

FIG. 5 shows the lowering of the display screen 100 down to be in close proximity with the uncured polymer and particles 110.

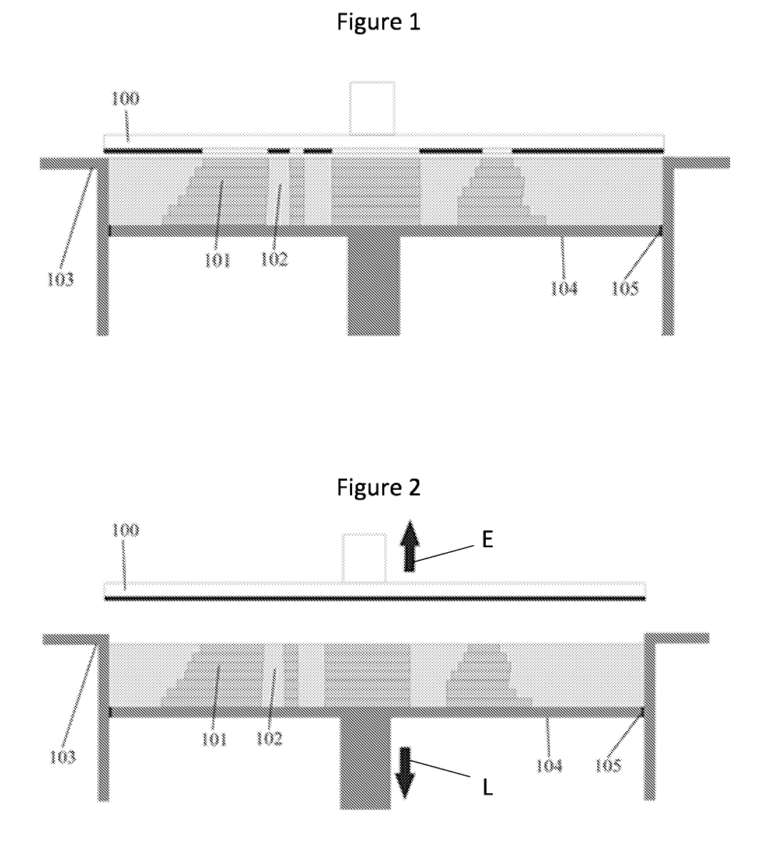

FIG. 1 shows the display screen in its illumination cycle, with a pattern of illumination corresponding with the desired curing pattern of the uncured, uppermost polymer layer, for converting the uncured polymer layer 110 selectively into uncured 102 and cured 101 polymer areas.

FIG. 2 shows the screen 100 being lifted upwards and the build platform 104 being lowered, before repeating the process in FIG. 3.

In illustrated orientation of 3D printer, the depth of the vat is at least as deep as the tallest object being created. After the final layer has been created the entire object will be below the level of the top of the machine. The method in this invention is not limited to this manner and alternative methods are possible.

After completion of the hardening process the uncured photopolymer and particles are removed and transferred to be washed or similar. The solvent used in the washing process may be a combination of warm water and a surfactant or can be a solvent such as isopropanol. Preferably, the object is then dried and can optionally could be post-cured by exposure to flood of light.

In the case of sand moulds, the mould is useful for the manufacture of moulds for the casting of metals. Without limitation, examples of the use of the methods of the present invention include the formation by metal casting for an automotive component or similar. The cavities in the sand mould are filled with the molten metals and the voids between the sand particles create permeability which allows the evacuation of gases.

In the case of metal and ceramic objects the finished object is of use as a solid metal or ceramic item. To achieve this the cured item is fired to remove the photopolymer and then increased in temperature up to a level necessary to fuse the sinterable inorganic particles. The heating rate during the photopolymer removal is preferably done at a rate of about 0.1° -1.0° C./min. to about 500°-650° C. Once the organic polymer is removed, the object is then heated to a sintering temperature appropriate for the inorganic material(s) to be fused. Preferably, the sintering is conducted to the temperature that the body has a density of at least 90% of the theoretical maximum density for the sinterable material, more preferably to at least 95% of theoretical density, most preferably at least 98% theoretical density.

The method may comprise the steps of (1) coating a first layer of the particles onto a surface; (2) coating a layer of photopolymer onto the particles; or alternatively (3) coating a combined layer of photopolymer and particles; (4) exposing said layer to the light emitted by the visual display screen to form the first layer of cured or partially cured polymer; (5) coating a second layer of the liquid photopolymer and particles onto the first layer of cured or partially cured polymer in the same manner; (6) exposing said second layer to the light emitted by the visual display screen to form a second layer of cured or partially cured polymer; (7) repeating steps (4) and (5) at least once to build up the three-dimensional object.

The wavelength of the light is a wavelength suitable to create polymerisation in the liquid polymer, this wavelength may be between within the spectrum visible to the human eye, i.e. above 400 nm and below 700 nm. The illumination source is an LCD screen. In the case that the LCD screen provided a patterned illumination, the light selectively exposes an area of a thin layer of the liquid, solidifying it to form the relevant layer of the shape that is being created. The shape of the cured polymer within that layer is determined by the shape of the image created on the LCD screen.

It has been found that the optimal resolution of the screen is obtained from screens with a high ratio of contrast ratio to total luminance. The contrast ratio of an LCD system is defined as the ratio of the luminance of its brightest colour (white) to that of its darkest colour (black). It has been found that ideally the contrast ratio should be above 1.0 and it is desirable for it to be as high as possible.

### EXAMPLES

Various aspects of the invention will now be particularly described with reference to the following example, which were all performed using the following procedures described below.

The standard particle and polymer 3D printer This is a description of the apparatus used in all these examples. All elements of the printer were constructed out of stainless steel unless explicitly stated. Two linear drive NEMA 17 motors with 8 mm lead screw and 1 mm pitch supplied by Lankeda were housed vertically in alternate sides of a chassis. One linear drive was used to support a replacement iPad® screen, shown as 100 in FIG. 1, of the dimensions 160 mm×120 mm. The iPad was connected with flexible cabling enabling it to retract freely to its most elevated position, up to 200 mm above the base of the unit. This was fitted so the screen was horizontal and facing downwards and was used as the LCD daylight illumination device. The other linear drive was used to support the moveable build platform of dimensions 160 mm×120 mm, shown as 104 in FIG. 1. The build platform was sealed into an opened bottomed vat of size 162 mm×122 mm size with a 2 mm diameter silicone gasket shown as 105 in FIG. 1. A doctor blade was supported at an angle of 45° to the vertical and 90° to the direction of travel, either side of the build platform, in bearing assemblies that enable free movement down the unit. Both linear motors could move freely up and down delivering accurate z-axis movement of 25 μm.

### Example 1—Pre-Mixed Sand and Photopolymer 3D Printer

In this experiment 100 g of photopolymer was constructed in the following manner; 95 g of Ebecryl 639 from Allnex of Belgium, which is a high functionality acrylated epoxy novolac resin diluted with 30% of trimethylolpropane triacrylate (TMPTA) and with 10% of hydroxy ethyl methacrylate (HEMA), was added to 2 g of bis(eta5-2,4-cylcopentadien-1-yl)-bis(2,6-difluoro-3-(1H-pyrrol-1-yl)-phenyl) titanium under the brand name Irgacure 784 from BASF and 3 g of Pentaerythritol Tetra(3-mercaptopropionate) under the brand name Thiocure PETMP from Bruno Bock. The solution was added to a glass vessel and mixed for 6 hours until the initiators were fully dissolved.

1 kg of Congleton HST 50 sand was obtained from Sibelco Minerals and Chemicals and was loaded into a mixing container. 50 g of the photopolymer was sprayed over the top of the sand so that it was completely covered. The contents of the container were given slow agitation for 10 minutes until the mix was homogenous. The container was left to stand for one hour to allow the excess polymer to drain to the bottom and sand was removed from the top. To achieve homogenous mixing, 15 g of volatile compatible solvent was added to the mixture, e.g. in this case isopropyl alcohol has been added. The mixture was vigorously mixed for 4 hours in an open lid container which allowed the solvent to fully evaporate.

The screen was elevated E to the top of the linear drive. The print platform was lowered L to be recessed by 0.1 mm from the top of the printer. A total of 5 g of the sand evenly coated with photopolymer was laid at one end of the 3D printer in front of the doctor blade. Constant force was delivered to both sides of the blade to evenly fill the recess in the vat to a depth of 0.1 mm, the cavity taking approximately 2.5 g of material, the excess being swept to the other side to be subsequently topped up and reused on the next pass.

The screen was lowered to its base position resting on top of the 3D printer, in this position it was approximately 0.1 mm above the level of the top of the layer. A mould for an object to be made was obtained digitally in three-dimensions, it was sliced and stored in an st1 format. The driver board for the iPad screen was set to generate maximum brightness, this was measured at 750 candela per square metre. The first sliced image was transferred to the iPad and it was left illuminating in black and white for a total of 40 seconds. The screen was then lifted again to its uppermost position;

the print platform was lowered by a further 0.1 mm and the process was repeated. After a total of 55 layers were made, the mould consisting of a number of cavities, was complete. The print platform was raised and transferred to a washing unit. Isopropyl alcohol was rinsed through to remove the unpolymerised photopolymer and sand. After 3 minutes, all the channels were flushed through and the mould was placed in an air-drying oven at 40° C. for one hour. The mould exhibited good operational strength and high heat deflection temperatures while at the same time the majority of the structure was open and gas permeable. It was further possible to prove its functionality when it was used to recreate that object in molten metal.

### Example 2—Sand and Photopolymer Separately Delivered in a 3D Printer

In this experiment 100 g of photopolymer was constructed in the following manner; 75 g of Ebecryl 639 from Allnex, 20 g of Hexanediol diacrylate from Allnex, 2 g of Irgacure 784 and 3 g of Thiocure PETMP were mixed in a glass vessel for 6 hours until the initiators were fully dissolved.

1 kg of Nugent 480 sand was obtained from the Nugent Sand Co Inc. and was loaded into a mixing container. A Xaar 1003 GS6 inkjet head with 360 nozzles per inch delivering greater than 1000 dpi, was loaded with the photopolymer. The photopolymer was heated to make the viscosity compatible with the Xaar1003 GS6 printhead.

The screen was elevated to the top of the liner drive. The print platform was lowered to be recessed by 0.1 mm from the top of the printer. The sand was evenly delivered into the recess by the doctor blade. The inkjet head was then primed and set to deliver the minimum amount to just coat the sand, without flooding it, by experimentation this was found to be a drop volume of 6 pL. The ink-jet head was given the same data as was directed to the LCD screen (e.g. in Example 1) and was made to dispense resin selectively over the sand, matching the illuminated sections of the screen in area. The resin and polymer on the platform was left to stand for 30 seconds for the resin to distribute through the layer thickness.

The screen was lowered to its base position resting on top of the top of the 3D printer, in this position is was approximately 0.1 mm above the level of the top of the layer. As before, the driver board for the iPad screen was set to generate maximum brightness and the first sliced image was transferred to the screen for a total of 40 seconds. The screen was then lifted again to its uppermost position; the print platform was lowered by a further 0.1 mm and the process was repeated. After a total of 55 layers, the mould providing a number of cavities, was complete. The print platform was raised and removed to a washing unit. Isopropyl alcohol was rinsed through it to remove the loose sand and photopolymer. After 3 minutes, all the channels were flushed through and the mould was placed in an air-drying oven at 40° C. for one hour. The mould was then used to recreate that object in molten metal. The mould was dimensionally strong, with a slightly lower gas permeability than in Example 1.

### Example 3—Mixture of Sand, Borosilicate Glass Particles and Photopolymer Dispensed in a 3D Printer

In this experiment 1 kg of photocurable slurry was manufactured. 500 g of Cerabeads 1450, with 300 g of Potters beads (Spheriglass® 5000 Solid Glass Spheres), 200 g of photosensitive resin with some low melting points additives (around 3% wt), and 3% of flow agents. After mixing the components with a high shear mixer rotating at 12,000 rpm for 30 minutes the sand mixture was dispensed at 150 micron layer thickness and hardened by a LCD screen emitting visible light. After the 3D object was made it was post cured under visible light for 2 hours. The object was placed in the oven and slowly increased by 1° C./min from 200° C. to 450° C. It has held at 450° C. for 2 hours and then slowly increased by 2° C./min up to 750° C., where the glass particles started softening and passing their glass transition point. The object was hold for 30 mins at the highest temperature and the gradually cooled (with the furnace switched off). Molten metal at below 1000° C. was poured to the manufactured mould and a successful cast metal object was derived.

### Example 4—Aluminium and Photopolymer Separately Delivered in a 3D Printer

In this experiment 100 g of photopolymer was constructed in the following manner; 55 g of Ebecryl 8307 is a urethane acrylate with high flexibility and excellent adhesion on metal made by Allnex, 20 g of Hexanediol diacrylate from Allnex, 20 g of Genomer 1122TF a monofunctional monomer from Rahn, 2 g of Irgacure 784 and 3 g of Thiocure PETMP were mixed in a glass vessel for 6 hours until the initiators were fully dissolved.

AlSi 12 aluminium alloy powder at average size 58 μm was obtained from Easy Composites Ltd and was loaded into a mixing container. A Xaar 1003 GS6 inkjet head with 360 nozzles per inch delivering greater than 1000 dpi, was loaded with the photopolymer.

The screen was elevated to the top of the liner drive. The print platform was lowered to be recessed by 0.1 mm from the top of the printer. The AlSi powder was evenly delivered into the recess by the doctor blade. The inkjet head was then primed and set to deliver the maximum amount, fully coating the AlSi powder, by experimentation this was found to be a drop volume of 24 pL. The ink-jet head made a dispense pass over the AlSi powder, the platform was left to stand for 30 seconds for the resin to distribute through the layer thickness.

The screen was lowered to its base position resting on top of the top of the 3D printer, in this position is was approximately 0.1 mm above the level of the top of the layer. As before the driver board for the iPad® screen was set to generate maximum brightness and the first sliced image was transferred to the screen for a total of 40 seconds. The screen was then lifted again to its uppermost position; the print platform was lowered by a further 0.1 mm and the process was repeated. After a total of 55 layers, the aluminium object held in shape by the photopolymer was complete. The print platform was raised and removed to a washing unit. Warm water and detergent were added to the water bath and it was sprayed throughout its structure, removing the loose AlSi powder and photopolymer. After 5 minutes the object was clean and was placed in an air-drying oven at 40° C. for 20 minutes. The unbound AlSi powder was reclaimed by filtration.

The AlSi-based object was placed into a ceramic cylinder and packed with ceramic beads to support it. It was stepped up in temperature from room temperature to 250° C., over 4 hours (approx. 60° C. per hour), then it was held at 250° C. for 4 hours, then elevated from 250° C. to 630° C., over 4 hours (approx. 100° C. per hour), it was held at 630° C. for 4 hours. Heat was turned off and it was allowed to cool naturally with the furnace door ajar, back to room temperature. An accurate representation of the object was created in solid aluminium. Its relative density was measured at 94%.

### Example 5—Silver and Photopolymer Separately Delivered in a 3D Printer

In this experiment the photopolymer was constructed in the same manner as Experiment 4. Silver powder with particle sizes between 4-7 μm was obtained from Alfa Aesar and was loaded into a mixing container. As before, the same ink-jet delivery system was used and was loaded with the photopolymer.

The screen was elevated to the top of the liner drive. The print platform was lowered to be recessed by 0.1 mm from the top of the printer. The sand was evenly delivered into the recess by the doctor blade. The inkjet head was then primed and set to deliver the maximum amount, fully coating the silver, by experimentation (as this depends upon particle surface shape and rheology and polymer flow characteristics) this was found by experimentation to be a drop volume of 18 pL. The ink-jet head made a dispense pass over the silver, the platform was left to stand for 30 seconds for the resin to further distribute.

The screen was lowered to its base position resting on top of the top of the 3D printer, in this position is was approximately 0.1 mm above the level of the top of the layer. As before the driver board for the iPad screen was set to generate maximum brightness and the first sliced image was transferred to the screen for a total of 40 seconds. The screen was then lifted again to its uppermost position; the print platform was lowered by a further 0.1 mm and the process was repeated. After a total of 55 layers, the silver object held in shape with photopolymer, was complete. The print platform was raised and removed to a washing unit. Warm water and detergent were added to the water bath and it was sprayed through removing the loose silver and photopolymer. After 5 minutes the object was clean and was placed in an air-drying oven at 40° C. for 20 minutes. The un-bound silver powder was reclaimed by filtration.

The silver object was placed into a ceramic cylinder and packed with sand to support it. It was stepped up in temperature from room temperature to 250° C., over 4 hours (approx. 60° C. per hour), then it was held at 250° C. for 4 hours, then elevated from 250° C. to 750° C., over 5 hours (approx. 100° C. per hour), it was held at 750 C for 4 hours. Heat was turned off and it was allowed to cool naturally with furnace door ajar, letting it fall back to room temperature. An accurate representation of the object was created in solid silver. It was assayed at 92.5% solid silver.

1-43. (canceled)

44. A 3D printer, the apparatus comprising:
a visual display screen having a luminance between 100 and 2000 cd/sqm;
a build platform having a build surface for use while stereolithographically printing a 3D object;
an actuation mechanism for varying the separation of the build surface and the visual display screen;
a deposition mechanism for depositing a deposition material of particulate or a particulate-photopolymer mixture; and
a thickness control mechanism for subtracting excess deposition material to leave a deposition layer of uniform thickness.

45. A 3D printer according to claim 44, wherein the thickness control mechanism is a doctor blade.

46. A 3D printer according to claim 44, wherein the thickness control mechanism is a roller.

47. A 3D printer according to claim 44, wherein the visual display screen is backlit by LEDs.

48. A 3D printer according to claim 44, wherein the visual display screen emits no light in the UV region.

49. A 3D printer according to claim 44, wherein the deposition mechanism is configured for selectively depositing the deposition material in correspondence to a cross-section of a 3D object.

50. A 3D printer according to claim 44, wherein the deposition mechanism further comprises a spraying mechanism for spraying a photopolymer onto the deposition material.

51. A 3D printer according to claim 50, wherein the deposition mechanism further comprises a spraying mechanism for selectively spraying the photopolymer onto the deposition material in correspondence to a cross-section of a 3D object.

52. A 3D printer according to claim 44, wherein the visual display screen comprises an image processor configured to control the visual display screen to display a sequence of photolithographic images, each corresponding with a cross-section of a 3D object.

53. A 3D printer according to claim 51, wherein the visual display screen is configured to provide uniform illumination onto the deposition material.

54. A 3D printer according to claim 44, wherein the actuation mechanism comprises a screen height adjustment mechanism.

55. A 3D printer according to claim 44, wherein the actuation mechanism comprises a build platform height adjustment mechanism.

56. A 3D printer according to claim 44, wherein the 3D printer comprises a controller, the controller being configured to control the relative separation of the build surface and the visual display screen, and the controller being further configured to control deposition of the deposition material by the deposition mechanism.

57. A 3D printer according to claim 56, wherein the actuation mechanism comprises a screen height adjustment mechanism, and the controller is configured to control the screen height adjustment mechanism to move the screen away from the build surface prior to a deposition step.

58. A 3D printer according to claim 56, wherein the actuation mechanism comprises a build platform height adjustment mechanism, and the controller is configured to control the build platform height adjustment mechanism to move the build platform away from the visual display screen following an exposure step.
